(19) United States
(12) Patent Application Publication
(10) Pub. No.: US 2021/0114424 A1
(43) Pub. Date: Apr. 22, 2021

(54) OSCILLATION DETECTION FOR VEHICLES AND TRAILERS

(71) Applicant: Daniel JAMISON, Derry, NH (US)

(72) Inventor: Daniel JAMISON, Derry, NH (US)

(21) Appl. No.: 17/072,475

(22) Filed: Oct. 16, 2020

Related U.S. Application Data
(60) Provisional application No. 62/916,947, filed on Oct. 18, 2019.

(51) Int. Cl. B60D 1/30; B60D 1/32

(52) U.S. Cl. CPC B60D 1/305; B60D 1/32

(57) ABSTRACT

Systems and methods for detecting oscillation of a trailer towed by a vehicle include implementing one or more SPR systems to acquire SPR information associated with the vehicle and/or the trailer and estimating a degree of swerve of the vehicle and/or a degree of lateral oscillation of the trailer based on the acquired SPR information.

### CROSS-REFERENCE TO RELATED APPLICATION

This application claims priority to and the benefit of, and incorporates herein by reference in its entirety, U.S. Provisional Patent Application No. 62/916,947, filed on Oct. 18, 2019.

### FIELD OF THE INVENTION

The present invention relates, generally, to detecting oscillations of vehicles and trailers and, more particularly, to detecting the oscillations using surface-penetrating radar (SPR) systems.

### BACKGROUND

Towing a trailer behind a vehicle often presents stability problems for both the vehicle and the trailer. Trailers tend to oscillate or sway back and forth in a lateral direction when being pulled behind a vehicle. The oscillations can be caused by a number of circumstances such as high horizontal crosswinds, excessive driving speed, severe changes in direction, etc. For example, the operator of a vehicle may swerve to avoid another vehicle aggressively merging from a freeway ramp. The quick swerving movement is transferred to the trailer, which may begin to oscillate. If the trailer oscillation is not addressed (e.g., with damping or other mitigation), it may continue to increase in magnitude; eventually the trailer may lift the rear end of the vehicle and push the vehicle from side to side, thereby significantly increasing the risk of a rollover accident.

Accordingly, there is a need for approaches to detecting and addressing vehicle oscillations resulting from towed loads—ideally, approaches that are easily implemented in conventional vehicles and/or trailers.

### SUMMARY

Embodiments of the present invention facilitate reliable detection of oscillations of a trailer and/or a vehicle using one or more SPR systems that can be easily employed thereon. In various embodiments, the vehicle and trailer are both equipped with SPR systems for obtaining SPR signals as the vehicle and trailer travel along a route. By analyzing the overlap information between the SPR signals obtained on the vehicle and on the trailer, oscillations in the vehicle or trailer and/or detachment of the trailer from the vehicle can be quickly detected. In one embodiment, upon detecting the oscillation and/or detachment associated with the vehicle/trailer, an alert is provided to warn the driver. Alternatively, a feedback signal may be provided to adjust vehicle operation (e.g., during autonomous or assisted vehicle driving).

In some embodiments, the obtained SPR signals may be analyzed to determine the current location of the vehicle/trailer for navigation purposes independent of oscillation detection. In addition, by comparing the current location of the vehicle/trailer against a previous location (e.g., acquired 10 seconds ago), oscillations in the vehicle/trailer can be detected as described in greater detail below. In one embodiment, the current location of the vehicle/trailer is localized to a location map (which may be created using the SPR system or may be an existing map obtained from another source, such as GOOGLE MAPS); departure of the vehicle/trailer from a lane or trail marked on the location map may then be detected. This may be beneficial for helping the driver navigate the vehicle where the traveling route has sparse trail markings and/or detecting when the driver is drunk or swerving dangerously.

Accordingly, in one aspect, the invention pertains to a system for detecting oscillation of one or more trailers towed by one or more vehicles. In various embodiments, the system includes the first and second SPR systems configured to acquire SPR information associated with the vehicle and the trailer, respectively; and a controller configured to estimate a degree of lateral oscillation of the trailer based on the SPR information acquired by the first and second SPR systems. In addition, the controller may be further configured to estimate expected SPR information associated with the trailer based at least in part on the acquired SPR information associated with the vehicle; compare the expected SPR information against SPR information actually acquired by the second SPR system on the trailer; and estimate the degree of lateral oscillation based at least in part on the comparison. In one implementation, the controller is further configured to estimate the expected SPR information by interpolating or extrapolating from the SPR information acquired by the first SPR system on the vehicle.

In various embodiments, the controller is further configured to (a) process the acquired SPR information associated with the vehicle and the trailer so as to identify locations thereof; (b) estimate the location of the trailer based at least in part on the location of the vehicle; and (c) compare the location of the trailer identified in step (a) against the location of the trailer estimated in step (b) so as to estimate the degree of lateral oscillation of the trailer. In addition, The system may further include an alert indicator on the vehicle for transmitting a visual or audio alert to a driver of the vehicle, and the controller may be further configured to cause activation of the alert indicator if the estimated degree of lateral oscillation of the trailer exceeds a predetermined threshold.

Alternatively or additionally, upon determining that the degree of lateral oscillation of the trailer exceeds a predetermined threshold, the controller may be further configured to autonomously operate an electrical, a mechanical and/or a pneumatic device of the vehicle so as to control a velocity, an acceleration, an orientation, an angular velocity and/or an angular acceleration of the vehicle for reducing the lateral oscillation of the trailer. In some embodiments, upon determining that the degree of lateral oscillation of the trailer exceeds a predetermined threshold, the controller is further configured to autonomously adjust a weight distribution of the vehicle or the trailer for reducing the lateral oscillation of the trailer.

In another aspect, the invention relates to a method of detecting oscillation of one or more trailers towed by one or more vehicles. In various embodiments, the method includes acquiring SPR information associated with the vehicle and the trailer; and based thereon, estimating a degree of lateral oscillation of the trailer. In addition, estimating the degree of lateral oscillation of the trailer may include estimating expected SPR information associated with the trailer based at least in part on the acquired SPR information associated with the vehicle; comparing the expected SPR information against the acquired SPR information; and estimating the degree of lateral oscillation based at least in part on the comparison. In one implementation, the expected SPR information is estimated by interpolating or extrapolating from the SPR information acquired by the acquired SPR information associated with the vehicle.

In various embodiments, the method further includes (a) processing the acquired SPR information associated with the vehicle and the trailer so as to identify locations thereof; (b) estimating the location of the trailer based at least in part on the location of the vehicle; and (c) comparing the location of the trailer identified in step (a) against the location of the trailer estimated in step (b) so as to estimate the degree of lateral oscillation of the trailer. In addition, the method may further include providing a visual or audio alert to a driver upon determining that the degree of lateral oscillation of the trailer exceeds a predetermined threshold.

Alternatively or additionally, the method may further include, upon determining that the degree of lateral oscillation of the trailer exceeds a predetermined threshold, autonomously operating an electrical, a mechanical and/or a pneumatic device of the vehicle so as to control a velocity, an acceleration, an orientation, an angular velocity and/or an angular acceleration of the vehicle for reducing the lateral oscillation of the trailer. In some embodiments, the method further includes, upon determining that the degree of lateral oscillation of the trailer exceeds a predetermined threshold, autonomously adjusting a weight distribution of the vehicle or the trailer for reducing the lateral oscillation of the trailer.

Another aspect of the invention relates to a system for detecting oscillation of a trailer towed by a vehicle. In various embodiments, the system includes an SPR system configured to acquire SPR information associated with the trailer; and a controller configured to estimate a degree of lateral oscillation of the trailer based on the acquired SPR information. In one implementation, the controller is further configured to estimate the degree of lateral oscillation of the trailer by comparing currently acquired SPR information against previously acquired SPR information.

In addition, the system may further include an alert indicator on the vehicle for transmitting a visual or audio alert to a driver of the vehicle, and the controller may be further configured to cause activation of the alert indicator if the estimated degree of lateral oscillation of the trailer exceeds a predetermined threshold. Alternatively or additionally, upon determining that the degree of lateral oscillation of the trailer exceeds a predetermined threshold, the controller may be further configured to autonomously operate an electrical, a mechanical and/or a pneumatic device of the vehicle so as to control a velocity, an acceleration, an orientation, an angular velocity and/or an angular acceleration of the vehicle for reducing the lateral oscillation of the trailer. In some embodiments, upon determining that the degree of lateral oscillation of the trailer exceeds a predetermined threshold, the controller is further configured to autonomously adjust a weight distribution of the vehicle or the trailer for reducing the lateral oscillation of the trailer.

In yet another aspect, the invention pertains to a system for detecting swerve of a vehicle. In various embodiments, the system includes an SPR system configured to acquire SPR information associated with the vehicle; and a controller configured to estimate a degree of swerve of the vehicle based on the acquired SPR information. In one implementation, the controller is further configured to estimate the degree of swerve of the vehicle by comparing currently acquired SPR information against previously acquired SPR information.

In addition, the system may further include an alert indicator on the vehicle for transmitting a visual or audio alert to a driver of the vehicle, and the controller may be further configured to cause activation of the alert indicator if the estimated degree of swerve of the vehicle exceeds a predetermined threshold. Alternatively or additionally, upon determining that the degree of swerve of the vehicle exceeds a predetermined threshold, the controller may be further configured to autonomously operate an electrical, a mechanical and/or a pneumatic device of the vehicle so as to control a velocity, an acceleration, an orientation, an angular velocity and/or an angular acceleration of the vehicle for reducing the swerve of the vehicle. In some embodiments, upon determining that the degree of swerve of the vehicle exceeds a predetermined threshold, the controller is further configured to autonomously adjust a weight distribution of the vehicle or the trailer for reducing the swerve of the vehicle.

As used herein, the terms “approximately” and “substantially” mean±10%, and in some embodiments, ±5%. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 schematically illustrates an exemplary vehicle and trailer equipped with one or more oscillation detection systems in accordance with various embodiments of the present invention.

FIG. 2 schematically depicts an exemplary approach for detecting oscillations of a trailer and/or a vehicle in accordance with various embodiments of the present invention.

FIG. 3 schematically depicts another exemplary approach for detecting oscillations of a trailer and/or a vehicle in accordance with various embodiments of the present invention.

FIG. 4 is a flow chart illustrating an exemplary approach for detecting oscillations of a trailer and/or a vehicle and, based thereon, performing autonomous or assisted vehicle driving in accordance with various embodiments of the present invention.

FIG. 5 schematically depicts an exemplary SPR system in accordance with various embodiments of the present invention.

### DETAILED DESCRIPTION

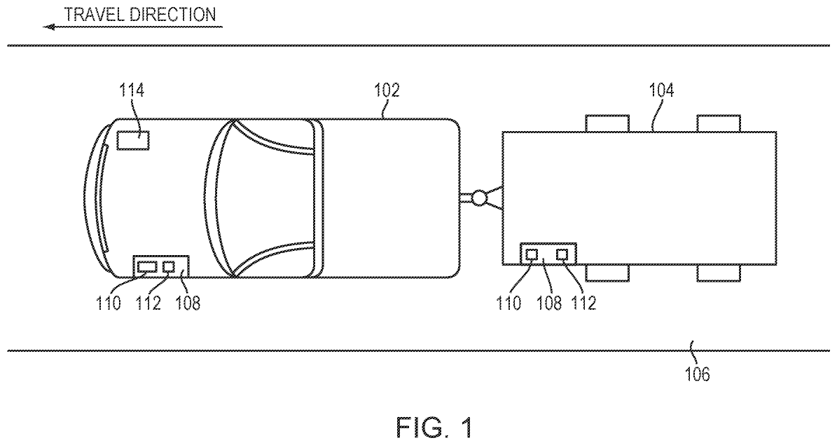

Refer first to FIG. 1, which illustrates an exemplary vehicle 102 towing a trailer 104 on a route 106. The vehicle 102 may be non-autonomous, semi-autonomous (e.g., some routine motive functions controlled by the vehicle 102), assisted, or fully autonomous (e.g., motive functions are controlled by the vehicle 102 without direct driver inputs). In various embodiments, the vehicle 102 and/or the trailer 104 are provided with an SPR system 108 for vehicle navigation and/or oscillation detection of the vehicle 102 and/or trailer 104 in accordance herewith. The SPR system 108 typically includes an SPR antenna array 110 fixed underneath and/or to the front (or any suitable portion) of the vehicle 102 and/or trailer 104. The SPR antenna array 110 is generally oriented parallel to the ground surface and extends perpendicular to the direction of travel. In an alternative configuration, the SPR antenna array 110 is closer to or in contact with the surface of the road. In one embodiment, the SPR antenna array 110 includes a linear configuration of spatially-invariant antenna elements for transmitting SPR signals to the road; the SPR signals may propagate through the road surface into the subsurface region and be reflected in an upward direction. The reflected SPR signals can be detected by the receiving antenna elements in the SPR antenna array 110. In various embodiments, the detected SPR signals are processed and analyzed in order to generate one or more SPR images of the subsurface region along the track of the vehicle 102 and/or trailer 104. If the SPR antenna array 110 is not in contact with the surface, the strongest return signal received may be the reflection caused by the road surface. Thus, the SPR images may include surface data, i.e., data for the interface of the subsurface region with air or the local environment. Suitable SPR antenna configurations and systems for processing SPR signals are described, for example, in U.S. Pat. No. 8,949,024 (the “'024 Patent”) and U.S. patent application Ser. No. 17/066,846 (filed on Oct. 9, 2020), the entire contents of which are hereby incorporated by reference.

In some embodiments, the SPR images are compared to SPR reference images that were previously acquired and stored for subsurface regions that at least partially overlap the subsurface regions for the route 106. The image comparison may be a registration process based on, for example, correlation; see, e.g., U.S. Pat. No. 8,786,485 and U.S. Patent Publication No. 2013/0050008, the entire disclosures of which are incorporated by reference herein. The route and/or locations of the vehicle 102 and the trailer 104 can be determined based on the comparison. Approaches for utilizing the SPR system for vehicle localization are described in, for example, the '024 Patent.

In one embodiment, the route and/or location data is used to create a real-time SPR map including the SPR information for navigating the vehicle/trailer. For example, based on the real-time SPR map, the velocity, acceleration, orientation, angular velocity and/or angular acceleration of the vehicle 102 may be continuously controlled via a controller 112 so as to maintain travel of the vehicle 102 along a predefined route.

Additionally or alternatively, the route and/or location data for the vehicle 102 and/or trailer 104 may be used in combination with the data provided by one or more other sensors or navigation systems, such as an inertial navigation system (INS), a global positioning system (GPS), a sound navigation and ranging (SONAR) system, a LIDAR system, a camera, an inertial measurement unit (IMU) and an auxiliary radar system, one or more vehicular dead-reckoning sensors (based on, e.g., steering angle and wheel odometry), and/or suspension sensors, to guide the vehicle 102 and/or trailer 104. For example, the controller 112 may localize the real-time SPR information to an existing map generated by the GPS. Again, based on the combination of the existing map and the obtained real-time SPR information, the vehicle/trailer may be continuously operated so as to travel along the predefined route. For ease of reference, the real-time SPR map including the SPR information and the combination of the existing map and real-time SPR information created based on the path/location data are generally referred to herein as the real-time SPR map information.

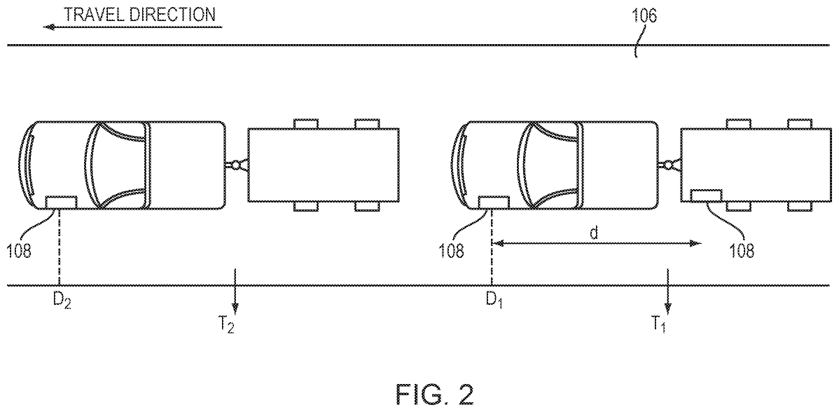

Generally, when the trailer 104 follows the track of the vehicle 102 without significant oscillation, the SPR map information associated with the trailer 104 can be estimated by interpolating or extrapolating from the acquired real-time SPR map information of the vehicle 102. For example, referring to FIG. 2, assuming the locations of the vehicle 102 detected by the SPR system 108 at time T=T₁ and T=T₂ are D₁ and D_{2,} respectively, and the distance between the SPR systems on the vehicle and the trailer is d, the location of the trailer 104 at time T=T₂ can be estimated based on the distance, d, and the speed of the vehicle 102 (which can be computed based on the travel distance of the vehicle 102, ΔD=D₂−D₁ during the time interval ΔT=T₂−T₁). If the estimated trailer location at time T=T₂ differs significantly from that measured by the SPR system 108 attached on the trailer 104 at time T=T₂—by, e.g., 10% or, in some embodiments, 20%—the trailer 104 may be experiencing significant lateral oscillations.

Additionally or alternatively, the controller 112 may interpolate or extrapolate the SPR images acquired by the vehicle 104 to estimate SPR images associated with the trailer 104. In one embodiment, the controller 112 is configured to compare the SPR images actually obtained by the SPR system 108 on the trailer 104 against the trailer SPR images estimated by the controller 112 using the SPR system on the vehicle 102. If there is substantial similarity (e.g., exceeding a predetermined threshold) between the actual and estimated SPR images, it can be assumed that the trailer 104 is not experiencing significant oscillations. If, however, the similarity is below the predetermined threshold, an alert may be issued and/or oscillation-correcting steps may be taken as further described below.

In some embodiments, the image comparison is performed on a pixel-by-pixel basis, where a “pixel” refers to an element of the image data array. Suitable similarity metrics include, for example, cross-correlation coefficients, the sum of squared intensity differences, mutual information (as the term is used in probability and information theory), ratio-image uniformity (i.e., the normalized standard deviation of the ratio of corresponding pixel values), the mean squared error, the sum of absolute differences, the sum of squared errors, the sum of absolute transformed differences (which uses a Hadamard or other frequency transform of the differences between corresponding pixels in two images), complex cross-correlation, and other techniques familiar to those of skill in the art to achieve image registration.

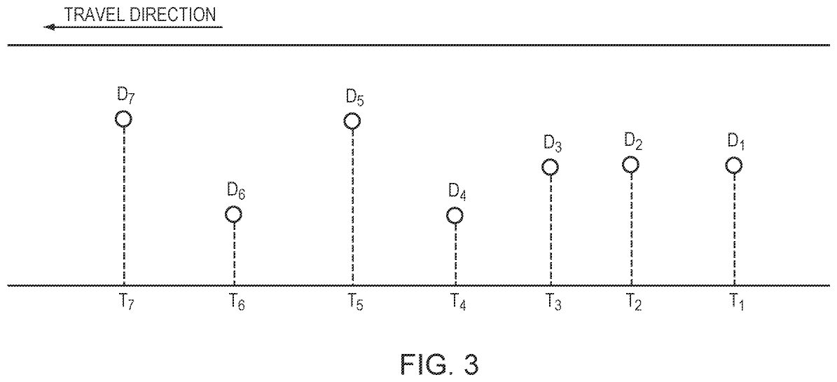

In some embodiments, oscillations of the trailer 104 are detected based on the SPR information acquired by the SPR system 108 on the trailer 104 only. For example, suppose, as shown in FIG. 3, that from time T=T₁ to T=T₇, the SPR information places the trailer 104 at locations D₁ to D₇. This pattern suggests that the trailer 104 starts to oscillate at time T=T₄. Similarly, based on the SPR information acquired by the SPR system 108 on the vehicle 102, the controller 112 may determine whether the vehicle 102 has departed from the trail or the lane in which it has been traveling. Separate and apart from oscillation detection, this capability may help the driver navigate the vehicle 102 when the traveling route has sparse trail markings. Additionally, this approach may detect when the driver is drunk or swerving dangerously.

Referring again to FIG. 1, in various embodiments, upon detecting that the vehicle/trailer is swerving away from its path of travel or is oscillating significantly, the controller 112 transmits a signal to an alert indicator 114 on the vehicle 102, which issues a visual and/or audible alert to warn the driver. Alternatively, the controller 112 may autonomously perform oscillation-correcting steps to mitigate the swerve/oscillation of the vehicle/trailer. For example, the controller may operate relevant parts (e.g., electrical, mechanical and pneumatic devices) of the vehicle 102 so as to adjust the velocity, acceleration, steering, orientation, angular velocity and/or angular acceleration of the vehicle 102 to mitigate the swerve/oscillation. In some embodiments, the controller 112 autonomously adjusts a weight distribution of the vehicle or the trailer for reducing the oscillation of the trailer. For example, the controller 112 may operate an actuator attached to a load associated with the vehicle 102 and/or trailer 104 for changing the location of the center of mass of the vehicle 102 and/or trailer 104 through electrical, mechanical, or pneumatic means. Additionally or alternatively, the controller 112 may adjust the angular momentum of the vehicle 102 and/or trailer 104 by imparting a torque through electrical, mechanical, pneumatic, or gyroscopic means (e.g., devices that use flywheels, spinning rotors and/or motorized gimbals).

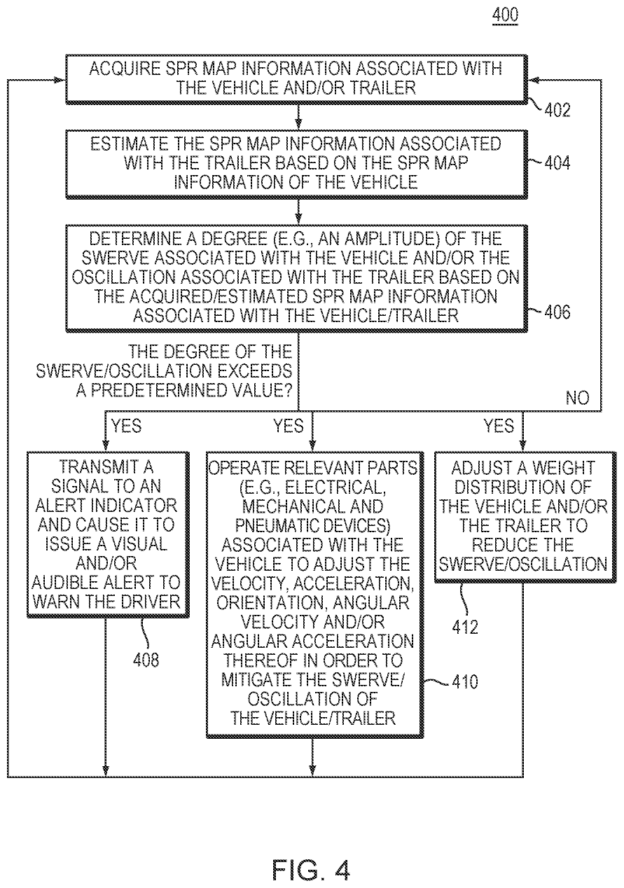

FIG. 4 illustrates an exemplary approach 400 for detecting oscillations of a vehicle 102 and/or a trailer 104 and, based thereon, performing autonomous or assisted vehicle driving in accordance herewith. In a first step 402, the controller 112 activates the SPR systems 108 associated with the vehicle 102 and the trailer 104 to acquire the real-time SPR map information associated therewith. In a second step 404, based on the SPR map information of the vehicle 102, the controller 112 estimates the SPR map information associated with the trailer 104 using, for example, interpolation and/or extrapolation. Based on the acquired and/or estimated SPR map information of the vehicle and/or the trailer, the controller 112 can then determine the degree (e.g., amplitude) of the swerve associated with the vehicle 102 and/or oscillation associated with the trailer 104 (step 406). For example, the controller 112 may compare the SPR information of the trailer 104, which is estimated based on the SPR information of the vehicle 102, against the SPR information of the trailer 104 actually acquired using the SPR system 108 associated therewith. Based on the comparison, the controller 112 determines the oscillation degree of the trailer. In another embodiment, the controller 112 compares the currently acquired SPR information of the vehicle/trailer against the previously acquired SPR information to determine the degree of oscillation associated with the trailer 104 and/or the degree of swerve associated with vehicle 102. If the degree of the swerve/oscillation exceeds a predetermined value (e.g., having an amplitude larger than 1 meter), the controller 112 may transmit a signal to an alert indicator and cause it to issue a visual and/or audible alert to warn the driver (step 408). Additionally or alternatively, the controller 112 may itself or, in some embodiments, cause a vehicle controller to operate relevant parts (e.g., electrical, mechanical and pneumatic devices) of the vehicle 102 to adjust the velocity, acceleration, steering, orientation, angular velocity and/or angular acceleration thereof in order to mitigate the swerve/oscillation of the vehicle/trailer (step 410). Additionally or alternatively, the controller 112 may adjust a weight distribution of the vehicle and/or the trailer to reduce the swerve/oscillation (step 412). Steps 402-412 can be iteratively performed during autonomous or assisted vehicle driving.

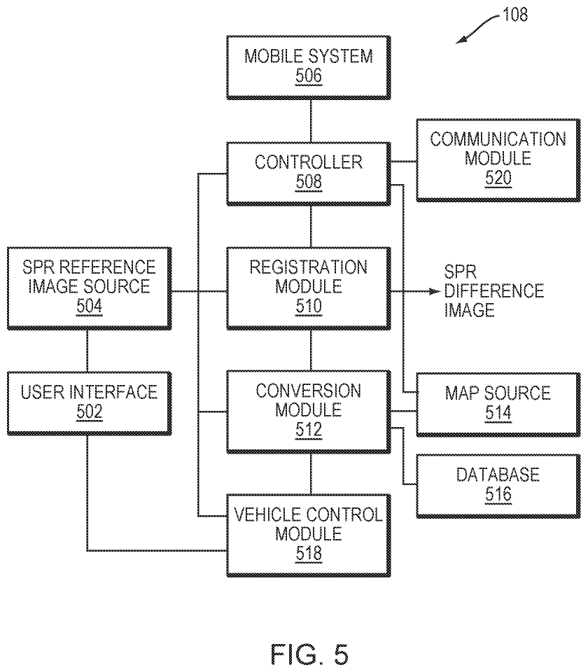

FIG. 5 depicts an exemplary SPR system 108 implemented in a vehicle 102 and/or trailer 104 for detecting the oscillation or swerve thereof in accordance herewith. The SPR system 108 may include a user interface 502 through which a user can enter data to define a route or select a predefined route. SPR images are retrieved from an SPR reference image source 504 according to the route. For example, the SPR reference image source 504 may be a local mass-storage device such as a Flash drive or hard disk; alternatively or in addition, the SPR reference image source 504 may be cloud-based (i.e., supported and maintained on a web server) and accessed remotely based on a current location determined by a GPS. For example, a local data store may contain SPR reference images corresponding to the vicinity of the vehicle's and/or trailer's current location, with periodic updates being retrieved to refresh the data as the vehicle/trailer travels.

The SPR system 108 also includes a mobile SPR system (“Mobile System”) 506 having an SPR antenna array 110. The transmit operation of the mobile SPR system 506 is controlled by a controller (e.g., a suitably programmed conventional processor) 508 that also receives the return SPR signals detected by the SPR antenna array 110. The controller 508 generates SPR images of the subsurface region below the road surface and/or the road surface underneath the SPR antenna array 110 in accordance, for example, with the '024 Patent.

The SPR image includes features representative of structures and objects within the subsurface region and/or on the road surface, such as rocks, roots, boulders, pipes, voids and soil layering, and other features indicative of variations in the soil or material properties (e.g., electromagnetic properties) of the soils and other subsurface materials. In various embodiments, a registration module 510 compares the SPR images provided by the controller 508 to the SPR images retrieved from the SPR reference image source 504 to locate the vehicle 102 and/or the trailer 104 (e.g., by determining the offset of the vehicle/trailer with respect to the closest point on the route). In various embodiments, the locational information (e.g., offset data or positional error data) determined in the registration process is provided to a conversion module 512 that creates a real-time map based on the obtained and reference SPR images. For example, the conversion module 512 may generate GPS data corrected for the vehicle/trailer positional deviation from the route.

Alternatively, the conversion module 512 may retrieve an existing map from a map source 514 (e.g., another navigation system, such as one based on GPS, or a mapping service), and then localize the obtained real-time SPR information to the existing map. In one embodiment, the SPR map information is stored in a database 516 in system memory and/or a storage device accessible to the controller 508.

In some embodiments, the controller 508 may, based on the SPR information acquired by the SPR systems on the vehicle 102 and/or trailer 104 and/or the created SPR/location map, determine whether the vehicle/trailer swerves away from its track, oscillates significantly on the track, or departs from a trail marked on the SPR/location map. If so, the controller 508 may then transmit a signal to a vehicle's alert indicators 114 for providing a visual or audio alert to warn the driver. In some embodiments, the controller 508 transmits a signal to a vehicle control module 518 that is coupled to the controller 508 for autonomously operating the vehicle based thereon. For example, the vehicle control module 518 may include or cooperate with electrical, mechanical and pneumatic devices in the vehicle 102 to adjust steering, orientation, velocity, pose and/or acceleration/deceleration of the vehicle 102, thereby reducing the swerve/oscillation of the vehicle/trailer.

In one embodiment, the controllers 508 of the SPR systems 108 on the vehicle 102 and trailer 104 transmit and/or receive the real-time SPR map information associated therewith via communication modules 520 on the vehicle 102 and trailer 104. The communication modules 520 may include a conventional component (e.g., a network interface or transceiver) designed to provide wired and/or wireless communications therebetween. In one embodiment, the communication modules 520 on the vehicle and trailer directly communicate with each other. Additionally or alternatively, the communication modules 520 may indirectly communicate with each other via infrastructure, such as the public telecommunications infrastructure, a roadside unit, a remote platooning coordination system, a mobile communication server, etc. The wireless communication may be performed by means of a wireless communication system with WiFi, Bluetooth, infrared (IR) communication, a phone network, such as general packet radio service (GPRS), 3G, 4G, 5G, Enhanced Data GSM Environment (EDGE), or other non-RF communication systems such as an optical system, etc. In addition, the wireless communication may be performed using any suitable modulation schemes, such as AM, FM, FSK, PSK, ASK, QAM, etc.

In addition, the controller(s) 112, 508 implemented in the vehicle and/or trailer may include one or more modules implemented in hardware, software, or a combination of both, and may be different (e.g., identical) devices or integrated as a single device. For embodiments in which the functions are provided as one or more software programs, the programs may be written in any of a number of high level languages such as PYTHON, FORTRAN, PASCAL, JAVA, C, C++, C#, BASIC, various scripting languages, and/or HTML. Additionally, the software can be implemented in an assembly language directed to the microprocessor resident on a target computer; for example, the software may be implemented in Intel 80×86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM. Embodiments using hardware circuitry may be implemented using, for example, one or more FPGA, CPLD or ASIC processors.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A system for detecting oscillation of at least one trailer towed by at least one vehicle, the system comprising:
first and second surface-penetrating radar (SPR) systems configured to acquire SPR information associated with the vehicle and the trailer, respectively; and
a controller configured to estimate a degree of lateral oscillation of the trailer based on the SPR information acquired by the first and second SPR systems.

2. The system of claim 1, wherein the controller is further configured to:
(a) estimate expected SPR information associated with the trailer based at least in part on the acquired SPR information associated with the vehicle;
(b) compare the expected SPR information against SPR information actually acquired by the second SPR system on the trailer; and
(c) estimate the degree of lateral oscillation based at least in part on the comparison.

3. The system of claim 2, wherein the controller is further configured to estimate the expected SPR information by interpolating or extrapolating from the SPR information acquired by the first SPR system on the vehicle.

4. The system of claim 1, wherein the controller is further configured to:
(a) process the acquired SPR information associated with the vehicle and the trailer so as to identify locations thereof;
(b) estimate the location of the trailer based at least in part on the location of the vehicle; and
(c) compare the location of the trailer identified in step (a) against the location of the trailer estimated in step (b) so as to estimate the degree of lateral oscillation of the trailer.

5. The system of claim 1, further comprising an alert indicator on the vehicle for transmitting a visual or audio alert to a driver of the vehicle, wherein the controller is further configured to cause activation of the alert indicator if the estimated degree of lateral oscillation of the trailer exceeds a predetermined threshold.

6. The system of claim 1, wherein upon determining that the degree of lateral oscillation of the trailer exceeds a predetermined threshold, the controller is further configured to autonomously operate at least one of an electrical, a mechanical or a pneumatic device of the vehicle so as to control at least one of a velocity, an acceleration, an orientation, an angular velocity or an angular acceleration of the vehicle for reducing the lateral oscillation of the trailer.

7. The system of claim 1, wherein upon determining that the degree of lateral oscillation of the trailer exceeds a predetermined threshold, the controller is further configured to autonomously adjust a weight distribution of the vehicle or the trailer for reducing the lateral oscillation of the trailer.

8. A method of detecting oscillation of at least one trailer towed by at least one vehicle, the method comprising:
(a) acquiring SPR information associated with the vehicle and the trailer; and
(b) based thereon, estimating a degree of lateral oscillation of the trailer.

9. The method of claim 8, wherein estimating the degree of lateral oscillation of the trailer comprises:
(c) estimating expected SPR information associated with the trailer based at least in part on the acquired SPR information associated with the vehicle;
(d) comparing the expected SPR information against the SPR information acquired in step (c); and
(e) estimating the degree of lateral oscillation based at least in part on the comparison.

10. The method of claim 9, wherein the expected SPR information in step (c) is estimated by interpolating or extrapolating from the SPR information acquired by the acquired SPR information associated with the vehicle.

11. The method of claim 8, further comprising:
(c) processing the acquired SPR information associated with the vehicle and the trailer so as to identify locations thereof;
(d) estimating the location of the trailer based at least in part on the location of the vehicle; and
(e) comparing the location of the trailer identified in step (c) against the location of the trailer estimated in step (d) so as to estimate the degree of lateral oscillation of the trailer.

12. The method of claim 8, further comprising providing a visual or audio alert to a driver upon determining that the degree of lateral oscillation of the trailer exceeds a predetermined threshold.

13. The method of claim 8, further comprising, upon determining that the degree of lateral oscillation of the trailer exceeds a predetermined threshold, autonomously operating at least one of an electrical, a mechanical or a pneumatic device of the vehicle so as to control at least one of a velocity, an acceleration, an orientation, an angular velocity or an angular acceleration of the vehicle for reducing the lateral oscillation of the trailer.

14. The method of claim 8, further comprising, upon determining that the degree of lateral oscillation of the trailer exceeds a predetermined threshold, autonomously adjusting a weight distribution of the vehicle or the trailer for reducing the lateral oscillation of the trailer.

15. A system for detecting oscillation of a trailer towed by a vehicle, the system comprising:
a surface-penetrating radar (SPR) system configured to acquire SPR information associated with the trailer; and
a controller configured to estimate a degree of lateral oscillation of the trailer based on the acquired SPR information.

16. The system of claim 15, wherein the controller is further configured to estimate the degree of lateral oscillation of the trailer by comparing currently acquired SPR information against previously acquired SPR information.

17. The system of claim 15, further comprising an alert indicator on the vehicle for transmitting a visual or audio alert to a driver of the vehicle, wherein the controller is further configured to cause activation of the alert indicator if the estimated degree of lateral oscillation of the trailer exceeds a predetermined threshold.

18. The system of claim 15, wherein upon determining that the degree of lateral oscillation of the trailer exceeds a predetermined threshold, the controller is further configured to autonomously operate at least one of an electrical, a mechanical or a pneumatic device of the vehicle so as to control at least one of a velocity, an acceleration, an orientation, an angular velocity or an angular acceleration of the vehicle for reducing the lateral oscillation of the trailer.

19. The system of claim 15, wherein upon determining that the degree of lateral oscillation of the trailer exceeds a predetermined threshold, the controller is further configured to autonomously adjust a weight distribution of the vehicle or the trailer for reducing the lateral oscillation of the trailer.

20. A system for detecting swerve of a vehicle, the system comprising:
a surface-penetrating radar (SPR) system configured to acquire SPR information associated with the vehicle; and
a controller configured to estimate a degree of swerve of the vehicle based on the acquired SPR information.

21. The system of claim 20, wherein the controller is further configured to estimate the degree of swerve of the vehicle by comparing currently acquired SPR information against previously acquired SPR information.

22. The system of claim 20, further comprising an alert indicator on the vehicle for transmitting a visual or audio alert to a driver of the vehicle, wherein the controller is further configured to cause activation of the alert indicator if the estimated degree of swerve of the vehicle exceeds a predetermined threshold.

23. The system of claim 20, wherein upon determining that the degree of swerve of the vehicle exceeds a predetermined threshold, the controller is further configured to autonomously operate at least one of an electrical, a mechanical or a pneumatic device of the vehicle so as to control at least one of a velocity, an acceleration, an orientation, an angular velocity or an angular acceleration of the vehicle for reducing the swerve of the vehicle.

24. The system of claim 20, wherein upon determining that the degree of swerve of the vehicle exceeds a predetermined threshold, the controller is further configured to autonomously adjust a weight distribution of the vehicle or the trailer for reducing the swerve of the vehicle.
